(19) United States
(12) Patent Application Publication
(10) Pub. No.: US 2008/0317370 A1
(43) Pub. Date: Dec. 25, 2008

(54) Method and System for Filtering Elongated Features

(75) Inventors: Raoul Florent, Ville d'Avray (FR); Christophe Samson, Le Guevin (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/092,868

(22) PCT Filed: Nov. 2, 2006
(86) PCT No.: PCT/IB06/54070

§ 371 Date: May 7, 2008

(30) Foreign Application Priority Data
Nov. 8, 2005 (EP) 05300902.3

(51) Int. Cl. G06K 9/40

(52) U.S. Cl. 382/260

(57) ABSTRACT

The present invention relates to a method of filtering an input image for producing an output image. The method comprising the steps of, for a first image point located at first spatial coordinates:—analysing intensity levels of the input image in a first vicinity of the first image point for calculating a first direction of filtering at said first image point;—computing an intensity level of a first output image point of a first output image by applying a first steerable filter kernel to the input image, which is centered at the first image point and oriented along the calculated first direction of filtering; selecting at least a second image point in a second vicinity of said first image point in the first output image;—computing an intensity level of at least one second output image point of a second output image by applying at least a second steerable filter kernel to the input image, which is centered at the at least second image point and oriented along a second direction of filtering;—calculating a linear combination of the first output image point and of the at least second output image point for providing an output intensity level;—applying said output intensity level to an output image point of said output image, said output image point having said first spatial coordinates.

### FIELD OF THE INVENTION

The present invention relates to a method of filtering an input image using elongated filters. The present invention also relates to a system for filtering an input image, said system implementing said method. The present invention finally relates to a computer program for carrying out said method.

The present invention finds its application in the general domain of image processing for enhancing elongated features and, in particular, in the domain of medical image processing for detecting a guide wire introduced in the body of a patient.

### BACKGROUND OF THE INVENTION

In medical image processing, it is often needed to enhance elongated features such as blood vessels, ribs or catheters. To this end, several techniques have been developed for designing oriented filters.

Document entitled “The Design and Use of Steerable Filters” by W. Freeman and E. Adelson, published in IEEE Transactions on Pattern Analysis and Machine Intelligence, Vol. 13 (9), pp. 891-906, in 1991, discloses a class of filters which can be rotated in an efficient way with a minimal computational cost, given a linear combination of a suitable filter basis.

Considering a two-dimensional (2D) image I comprising image points X, a steerable filter h in 2D is defined in the following way:

$$h ( x , y ) = {\sum }_{k = 1}^{M} {\sum }_{i = 0}^{k} {α}_{k , i} \frac{{\partial }^{k - i}}{\partial {x}^{k - i}} \frac{{\partial }^{i}}{\partial {y}^{i}} g ( x , y )$$

where g is an arbitrary isotropic window function, such as, for instance, a Gaussian function.

The filter h is steerable in a direction θ, which means that the convolution of a function f of the image I with any rotated version of h can be expressed as the linear combination:

$$f ( X ) * h ( {R}_{θ} X ) = {\sum }_{k = 1}^{M} {\sum }_{i = 0}^{k} {b}_{k , i} ( θ ) {f}_{k , i} ( X ) ,$$

with X=(x, y), R_{θ} a rotation matrix and b_{k,I} orientation-dependent weights.

Functions f_{k,i} are filtered versions of f such that:

$${f}_{k , i} ( x , y ) = f ( x , y ) * ( \frac{{\partial }^{k - i}}{\partial {x}^{k - i}} \frac{{\partial }^{i}}{\partial {y}^{i}} g ( x , y ) )$$

and where the orientation-dependant weights b_{k,i} are trigonometric polynomials defined by:

$${b}_{k , i} ( θ ) = ( {\sum }_{j = 0}^{k} {α}_{k , j} {\sum }_{l , m ∈ S ( k , i , j )} ( \begin{matrix}k - j \\ l\end{matrix} ) ( \begin{matrix}j \\ m\end{matrix} ) {( - 1 )}^{m} {cos ( θ )}^{j + ( l - m )} {sin ( θ )}^{( k - j ) - ( l - m )} )$$

with the set S(k, i, j)={l,m/0≦l≦k−i; 0≦m≦i; k−(l+m)=j}.

Once the f_{k,i} are determined, the convolution off with h (R_{θ}X) can be evaluated in an efficient way through a linear sum of weighted terms.

A drawback of this technique is that elongated oriented filters can only be obtained by selecting a class of steered filters with high order M of derivatives in the previous equations. However, it is known that high order derivatives lead to numerical instabilities. Therefore, in practice, mainly steerable filters of order 2 are used, which restricts to matching shortly elongated structures.

### SUMMARY OF THE INVENTION

An object of the invention is to provide a solution for filtering elongated features, which is more efficient.

This is achieved by a method of filtering an input image and of producing an output image, said input image comprising image points comprising intensity levels, to which are associated spatial coordinates, said method comprising the steps of:
analysing intensity levels of the input image in a first vicinity of the first image point for calculating a first direction of filtering at said first image point;
computing an intensity level of a first output image point of a first output image by applying a first steerable filter kernel to the input image, which is centered at the first image point and oriented along the calculated first direction of filtering;
selecting at least a second image point in a second vicinity of said first image point in the first output image;
computing an intensity level of at least one second output image point by applying at least a second steerable filter kernel to the input image, which is centered at the second image point and oriented along a second direction of filtering;
calculating a linear combination of the first output image point and of the at least second output image point;
applying said calculated linear combination to an intensity level of an output image point of said output image, to which are associated said first spatial coordinates.

With the invention, an elongated steerable filter kernel is designed, centered at the first image point, as the linear combination of a centered steerable filter kernel, the first steerable filter kernel, and at least one off-centered steerable filter kernel, the second steerable filter kernel, centered at the second image point. The first and second kernels are obtained, for instance, from derivatives of an isotropic function such as the Gaussian function. The elongation of the filter kernel is provided by contributions of centered and off-centered filter kernel components to the linear combination. Therefore, there is no need for deriving the isotropic function at high orders, which allows the design of a stable elongated filter. Moreover, neither the design of a steerable filter kernel nor the linear combination involve high computational costs. Therefore, with the invention, an efficient solution for filtering elongated features is provided.

In accordance with a first embodiment of the invention, the second direction of filtering is equal to the first direction of filtering. Consequently, the off-centered contribution of the second steerable filter kernel to the linear combination has the effect of extending the first steerable filter kernel along the first direction of filtering. An advantage of this first embodiment of the invention is to produce a very elongated filter having strong shape-constraints capable of detecting or enhancing noisy elongated structures.

In accordance with a second embodiment of the invention, the method further comprises a step analysing intensity levels of the input image in a second vicinity of the second image point for calculating the second direction of filtering at said second image point. Therefore, the contribution of the second steerable filter kernel to the linear combination has the effect of extending the first steerable filter kernel in the direction of an elongated feature present in the image at the second image point. A consequence is that a curved elongated filter is designed, which fits better with the local intensity of the image and brings improved feature enhancement results on elongated curved features.

In accordance with a third embodiment of the invention, the step of selecting at least a second image point comprises a sub-step of selecting a third image point in a third vicinity of said first image point and the step of computing an intensity level of one at least second output image point comprises a sub-step of computing an intensity level of a third output image point, which is centered at the third image point and oriented along a third direction of filtering. Moreover, the combination step is intended to calculate the linear combination of the first steerable filter kernel centered at the first image point, of the second steerable filter kernel centered at the second image point and of a third steerable filter centered at the third image point. An advantage of the third embodiment of the invention is that the first steerable filter kernel is extended on both sides of the first image point. Therefore, an increased elongation can be obtained.

Preferably, the third steerable filter kernel is oriented along the calculated second direction of filtering. An advantage is that the elongation of the first steerable kernel is the same on both sides of the first image point.

Preferably, the third output image point is located on a line comprising the first output image point and the second image point. A consequence is that a very elongated steerable filter is obtained. An advantage is that it allows the detection of noisy long rectilinear features, which are not detected by classical steerable filters.

Preferably, the third image point is selected in such a way that said third image point is symmetric on the line to the second image point with respect to first image point. An advantage is that the elongation of the first steerable kernel is symmetric with respect to the first image point.

In a fourth embodiment of the invention, the second and third output image points are located on a curve comprising the first output image point. Such a curve is determined from a step of analysing intensity levels of the first output image in a vicinity of the first output image point. With this fourth embodiment of the invention, a curved elongated filter is defined which fits better with complex elongated structures of the input image. Preferably, the third image point is selected in such a way that said third image point is symmetric, on the curve, to the second image point with respect to the first image point.

The invention also relates to an image processing system for filtering an image comprising image points, said system using said method.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 is a functional block diagram of a method of filtering an image in accordance with the invention;

FIG. 2 is a schematical drawing, which describes the design and use of a steerable filter in accordance with the prior art;

FIGS. 3A and 3B are schematical drawing for illustrating the influence of parameters like the direction of filtering or the distance between first and second image points on the design of an elongated steerable filter kernel in accordance with the invention;

FIGS. 4A and 4B are schematical drawing for illustrating possible ways of producing an elongated steerable filter kernel in accordance with the invention;

FIG. 5A is a schematical drawing of an elongated steerable filter obtained when the second image point is located on a line comprising the first output image point and oriented along the calculated first direction of filtering;

FIG. 5B is a schematical drawing of an elongated steerable filter obtained when the second image point is located on a curve comprising the first output image point;

FIG. 6 is an example of horizontally elongated filters in accordance with the invention;

FIGS. 7A and 7B are examples of input and output images obtained by application of an elongated steerable filter in accordance with the invention for ridge detection;

FIG. 8 is a schematical drawing of a system for filtering in accordance with the invention.

### DETAILED DESCRIPTION OF THE INVENTION

The invention relates to a method of filtering an input image for producing an output image. In the following, an image is considered as a 2D array of image points, an image point comprising an intensity level and being located in the 2D array by spatial coordinates of a referential of the image. It should be noted however that 3D arrays of image points are also in the scope of the invention.

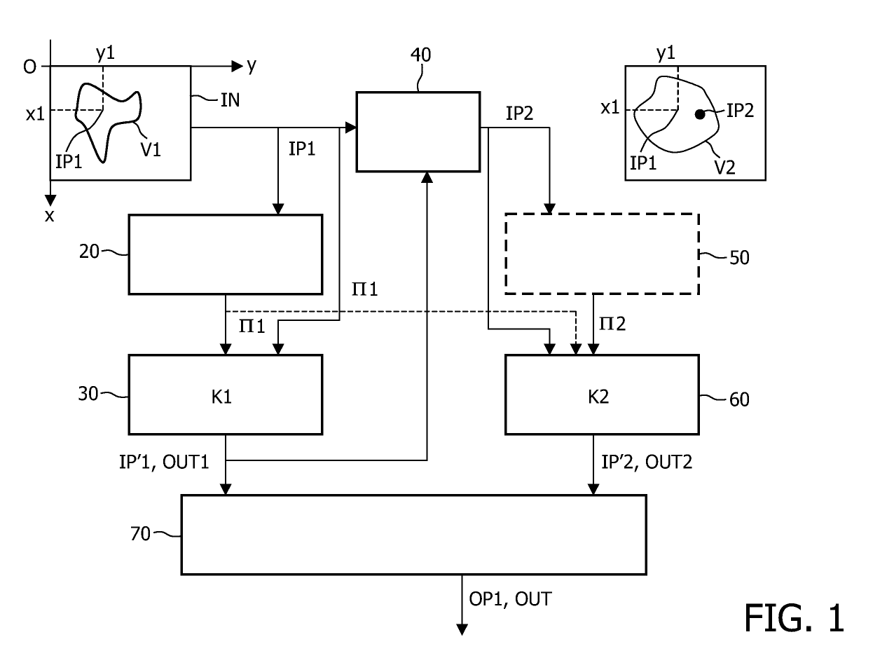

Referring to FIG. 1, the method in accordance with the invention applies to an input image IN comprising a first image point IP₁ comprising an intensity level IL₁ to which are associated spatial coordinates (x₁,y₁) in a referential (O,x,y) of the input image. Such a method comprises a step 20 of analysing intensity levels IL of the input image in a first vicinity V₁ of the first image point IP₁ for calculating a first direction of filtering θ₁ at said first image point IP₁. It should be noted that the vicinity V₁ is a set of image points belonging to the input image IN, which are located in a neighbourhood of the first image point IP₁. Such a set of image points is for instance defined by using a maximal distance threshold with respect to the first image point IP₁. The maximal distance threshold depends on a size of the elongated structures which should be enhanced in the input image.

This analysis is performed by using known image processing techniques, for instance by applying a gradient operator to the input image.

The step 20 is followed by a step 30 of computing an intensity level IL′₁ of a first output image point IP′₁ of a first output image OUT₁ by applying a first steerable filter kernel K₁ to the input image IN, which is centered at the first image point IP₁ and oriented along the calculated first direction of filtering θ₁.

The method in accordance with the invention further comprises a step 40 of selecting at least one second image point IP₂ in a second vicinity V₂ of said first image point IP₁ in the input image IN. It should be noted that the second vicinity V₂ is not necessarily the same as the first vicinity V₁. As a matter of fact, the maximal distance threshold used for defining the second vicinity V₂ should be related to the length of the first steerable filter kernel K₁.

The method in accordance with the invention further comprises a step 50 of computing an intensity level IL′₂ of the at least second output image point IP₂ by applying at least a second steerable filter kernel K₂ to the input image IN, said second steerable filter kernel K₂ being centered at the at least second image point IP₂ and oriented along a second direction of filtering θ₂. A second output image point IP′₂ is obtained. A step 60 of calculating a linear combination of the intensity level IL′₁ of the first output image point IP′₁ and of the intensity level IL′₂ of the at least second output image point IP′₂ is performed, which provides an output intensity level IL_{OUT}. Said output intensity level IL_{OUT} is further applied to a first output image point OP₁ of the output image, said first output image point OP₁ being located at the first spatial coordinates (x₁, y₁) of the first image point IP1.

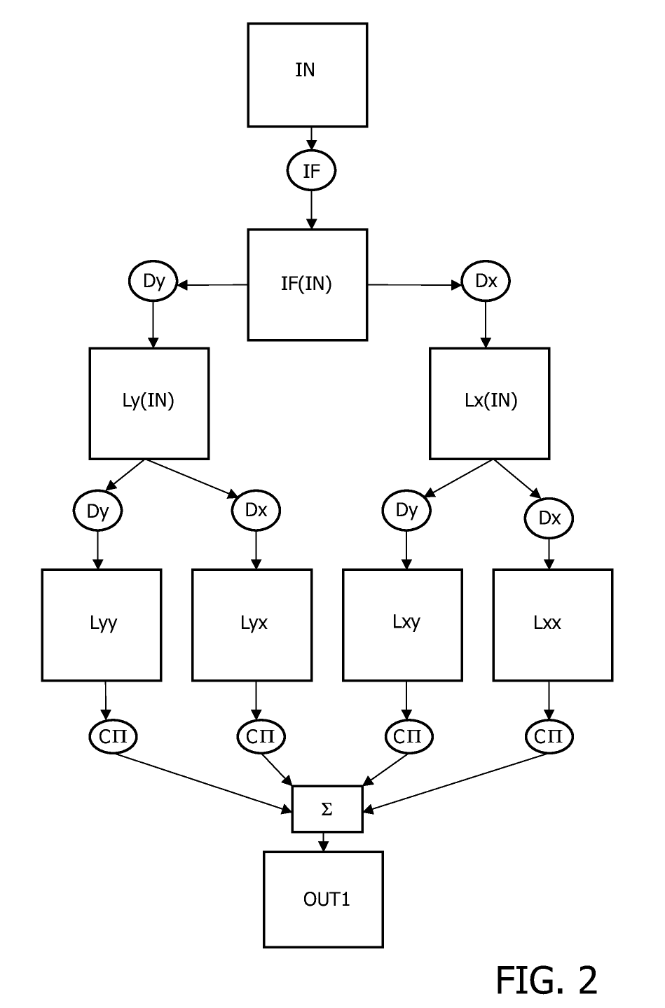

FIG. 2 describes in a schematical way a possible solution for designing a steerable filter kernel in a direction θ and applied to the input image IN. The input image IN is firstly filtered by an isotropic function IF, which is, for instance, the Gaussian function. An intermediate image IF(IN) is obtained. The intermediate image IF(IN) is smoother than the input image IN and more adapted to further derivation. In a second step, the intermediate image IF(IN) is filtered by linear derivative operators Dₓ, D_{y} in order to provide derivative images Lₓ(IN), L_{y}(IN), Lₓₓ(IN), L_{yy}(IN), L_{xy}(IN) of the intermediate image IF(IN). For instance, the second order derivative in the x direction of the intermediate image Lₓₓ(IN) is obtained by applying the derivative operator Dₓ twice to the intermediate image. In the example of FIG. 2, the derivatives of the intermediate image at the first and second orders are provided, but higher order derivatives can be obtained in the same way by further applying the derivative kernels Dₓ, D_{y} to the derivative image obtained at the second order.

In order to take into account of the direction θ, the derivative images Lₓ(IN), L_{y}(IN), Lₓₓ(IN), L_{yy}(IN), L_{xy}(IN) are simply multiplied by theta-dependent coefficients Cθ as explained in the introductory part of the present patent application. A response OUT₁ of the input image to the steerable filter kernel is thus obtained by calculating a weighted sum of derivative images, where the weights are orientation-dependent.

An advantage of such a technique for designing and using steerable filters is that it has a low computational cost. It should be noted that this technique is well-known by the skilled person and that another technique could have been used as well. For instance, a steerable filter along the direction θ can be realized by rotating image points comprised within a vicinity of the first image point with the angle θ and by applying an horizontal elongated filter to the rotated vicinity.

In the following, we consider a first steerable filter kernel K₁, which is oriented in a first direction θ₁. The steerable filter kernel K₁ is obtained by successively deriving an isotropic function. A first image point IP(x₁,y₁) having an intensity level IL₁ is filtered by the first steerable filter kernel K₁ into a first output image point IP′₁(x₁, y₁)=IL′₁. With the invention, an elongated steerable filter kernel is obtained by calling a second steerable filter kernel K₂ at least one second image point IP₂(x₂, y₂), which is located in a second vicinity V₂ of the first image point IP₁(x₁,y₁). The second steerable filter kernel is oriented along a direction θ₂.

The elongated steerable filter kernel K can then be defined by the following equation:

$$K ( {x}_{1} , {y}_{1} ) = \frac{{K}_{1 , {θ}_{1}} ( {x}_{1} , {y}_{1} ) + α \cdot {K}_{2 , {θ}_{2}} ( {x}_{2} , {y}_{2} )}{1 + α}$$

with α a real positive weighting factor and a distance between the first and second image points D(IP₁, IP₂)=ρ, where ρ is a real positive.

It should be noted that the first and second steerable kernels may themselves be linear combinations of filters.

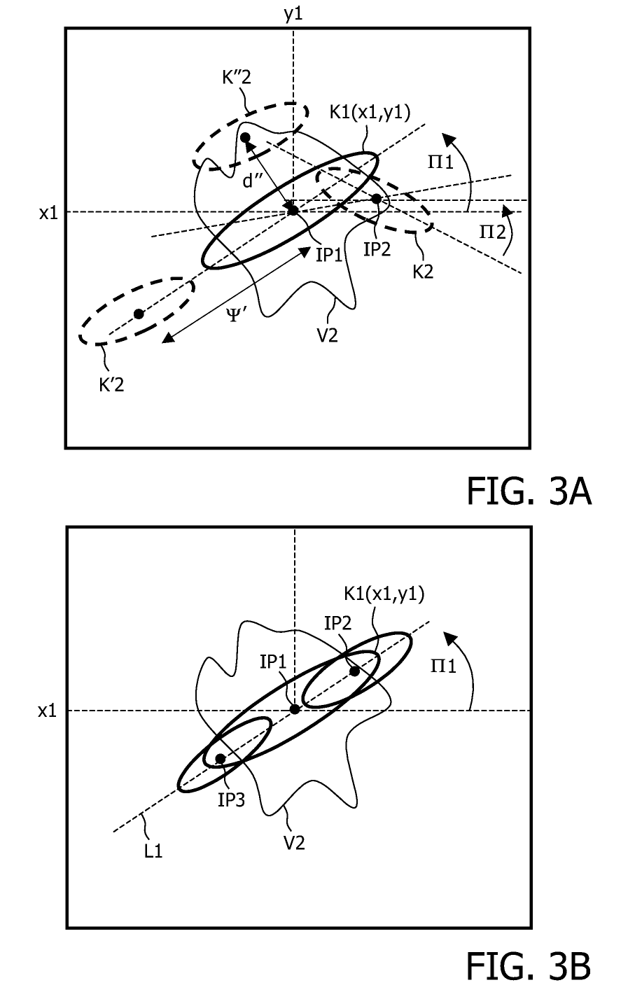

Referring to FIG. 3A, the final shape of the designed elongated steerable filter kernel K depends on various parameters which are:
the distance ρ between the first and the second image points IP₁, IP₂ with respect to a size of the first and second steerable filter kernels K₁, K₂. In particular, if the second image point is chosen at a distance ρ′ from the first image point which is greater than the size of the steerable filter kernel K₁, then the elongated filter is likely to have a discontinuity or a hole in its shape. When using a Gaussian function as an isotropic filtering kernel, the distance ρ should be of the order of magnitude \sqrt{2σ}, where σ is the magnitude of the standard deviation of the Gaussian function;
a distance d between the second image point and a line comprising the first image point and oriented along the direction θ₁. If the distance d″ is of the same order or greater than the width of the first steerable kernel, then the extension of the steerable filter kernel will not occur in its length but in its width;
a difference of orientation between the first orientation θ₁ of the first steerable kernel K₁ and the second orientation θ₂ of the second steerable kernel K₂. If the orientations θ₁ and θ₂ are too different, then no elongation is obtained but a strong curvature of the designed steerable filter kernel.

Therefore, some conditions need to be satisfied in order to get an elongated steerable filter kernel, which is elongated along its length.

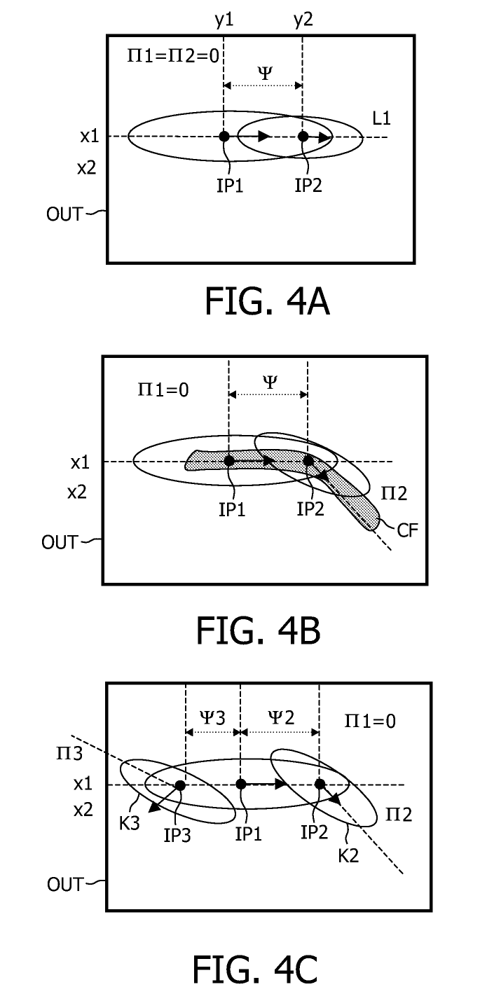

Preferably the at least second output image point IP₂ is located on a line L₁ comprising the first output image point IP₁ and oriented along the calculated first direction of filtering θ₁, as shown in FIG. 4A.

Referring to FIG. 4A and in accordance with a first embodiment of the invention, the second direction of filtering θ₂ is equal to the first direction of filtering θ₁. Consequently, the off-centered contribution of the second steerable filter kernel K₂ to the linear combination has the effect of extending the first steerable filter kernel K₁ along the first direction of filtering. An advantage of this first embodiment of the invention is to produce a very elongated filter having strong shape-constraints capable of detecting or enhancing noisy elongated structures.

Referring to FIG. 4B and in accordance with a second embodiment of the invention, the method further comprises a step analysing intensity levels of the input image in a second vicinity V₂ of the second image point for calculating the second direction of filtering θ₂ at said second image point IP₂. As already mentioned above, this analysis is performed by using known image processing techniques, for instance by applying a gradient operator to the input image.

Therefore, the contribution of the second steerable filter kernel K₂ to the linear combination has the effect of extending the first steerable filter kernel K₁ in the direction of a curved feature CF present in the image at the second image point. A consequence is that a curved elongated filter K is designed, which fits better with the local intensity of the image and brings improved feature enhancement results on elongated curved features CF.

Referring to FIG. 4C and in accordance with a third embodiment of the invention, the step of selecting at least a second image point IP₂ comprises a sub-step of selecting a third image point IP₃ in a third vicinity V₃ of said first image point IP₁ and the step of computing an intensity level of one at least second output image point comprises a sub-step of computing an intensity level of the third output image point IP₃, which is centered at the third image point and oriented along a third direction of filtering θ₃, from derivatives of an isotropic function. Moreover, the combination step is intended to calculate the linear combination of the first steerable filter kernel K₁ centered at the first image point IP₁, of the second steerable filter kernel K₂ centered at the second image point IP₂ and of a third steerable filter K₃ centered at the third image point IP₃. An advantage of the third embodiment of the invention is that the first steerable filter kernel K₁ is extended on both sides of the first image point IP₁. Therefore, an increased elongation is obtained.

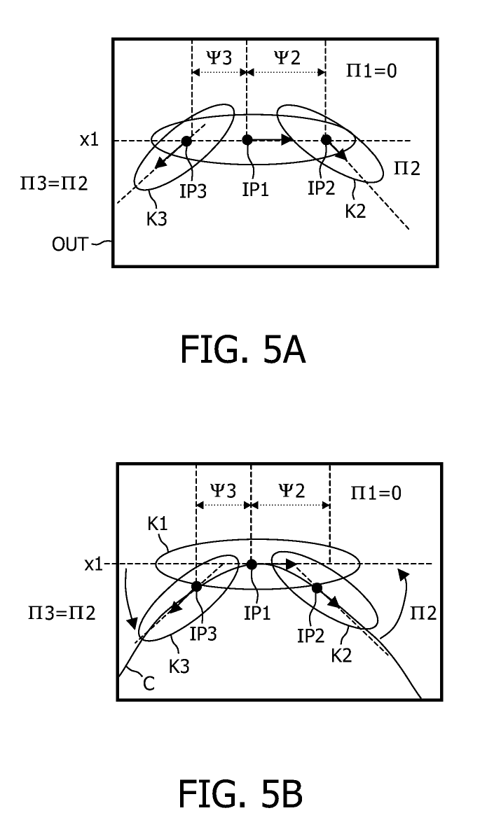

Referring to FIG. 5A, the third steerable filter kernel is preferably oriented along the calculated second direction of filtering θ₂ and the third image point is selected on the line in such a way that said third image point is symmetric to the second image point with respect to the first image point.

An advantage is that the elongation of the first steerable kernel is the same on both sides of the first image point.

Referring to FIG. 5B and in accordance with a fourth embodiment of the invention the second and third output image points IP₂, IP₃ are located on a curve C comprising the first output image point IP₁. Such a curve is either a circle, which is defined by a curvature radius or a parabolic curve or any kind of curve, which is defined on the basis of analysis parameters calculated on the image such as the curvature of the elongated features. Advantageously, the curve has a shape which is related to the elongated features present in the image. Therefore, the defined curve can be used as a guide for designing of a curved elongated filter K which fits better with complex elongated structures of the input image.

Preferably, the third image point IP₃ is selected in such a way that said third image point IP₃ is symmetric on the curve C to the second image point IP₂ with respect to the first image point. An advantage is that the elongation of the first steerable kernel is the same on both sides of the first image point.

In the following, the method in accordance with the invention will be described in more detail in the particular case of steerable filter kernels computed from second order derivatives of the Gaussian function. It should be noted that any kind of isotropic function may be used as well and is in the scope of the present invention.

A first steerable filter kernel K₁ is defined at an image point IP₁(x₁,y₁) by the following equation:

K₁(IP₁,r)=K₁(x₁,y₁)=r^{t}(x₁,y₁)·H_{G}(x₁,y₁)·r(x₁,y₁)

where r=(−sin θ, cos θ) is the vector of direction orthogonal to θ at image point IP₁(x₁, y₁) and H_{G}(x, y), the Gaussian second order derivative kernel defined by:

$${H}_{G} ( x , y ) = ( \begin{matrix}\frac{{\partial }^{2} g ( x , y )}{\partial {x}^{2}} & \frac{{\partial }^{2} g ( x , y )}{\partial x \partial y} \\ \frac{{\partial }^{2} g ( x , y )}{\partial x \partial y} & \frac{{\partial }^{2} g ( x , y )}{\partial {y}^{2}}\end{matrix} )$$

With the invention, this first steerable filter kernel is extended from an extrapolation of at least a second and third steerable filter kernels K₂, K₃ at a distance ρ along the direction θ from the central pixel of application IP₁. Those second and third extrapolated steerable kernels are referred to as off-centred kernels, since they contribute to the output at the central value, but involve kernel generation at non-central locations.

In a simplified case where a single steerable filter kernel K₁=K₂=K₃ is considered and the second and third image points IP₂, IP₃ are located on a line comprising the first image point IP₁ and oriented along the first direction θ₁, the final second order kernel expression at pixel IP₁(x₁,y₁) is:

$$K ( {IP}_{1} , r ) = \frac{1}{1 + 2 β} ( {K}_{1} ( {IP}_{1} , r ) + β ( {K}_{1} ( {IP}_{1} + ρ \cdot {r}_{⊥} , r ) + {K}_{1} ( {IP}_{1} - ρ \cdot {r}_{⊥} , r ) ) )$$

with β a real positive weighting factor.

It should be noted that when the kernel is to be evaluated at non-integer coordinates, interpolation can be involved.

As already mentioned above, the final shape of the elongated filter K depends on the parameters such as the distance ρ and the weighting factor β. It should be noted that a way of designing an elongated filter with a smooth profile is to choose ρ and β in such a way that the second derivative along the orientation θ₁ of the Gaussian function is zero at the first image point IP₁.

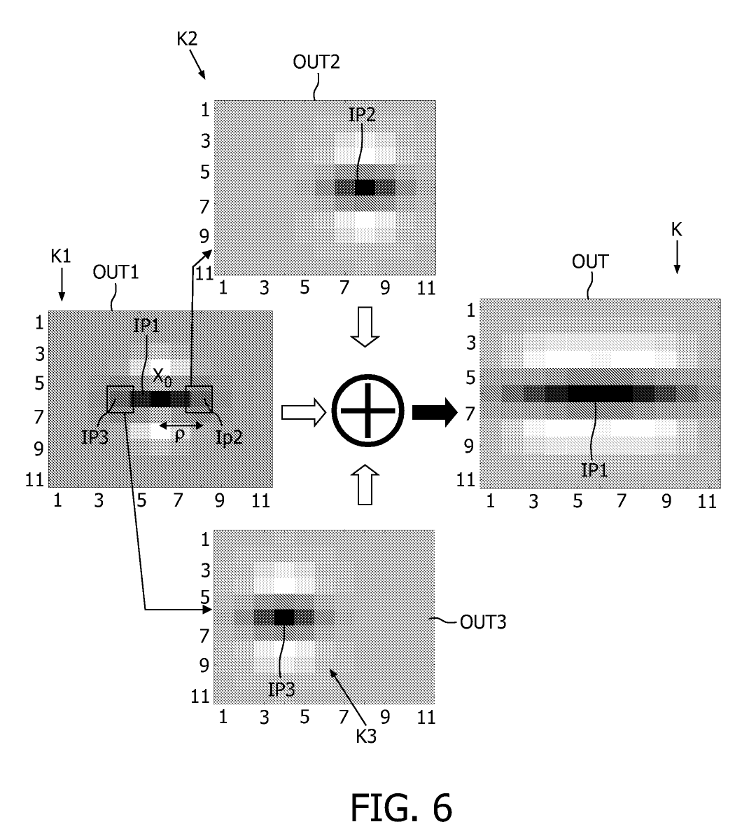

FIG. 6 gives an example of an elongated steerable filter computed from second order Gaussian derivatives, with a single steerable kernel K₁=K₂=K₃ and a direction of filtering θ₁=θ₂=θ₃. An input image IN comprising a first image point IP₁ is filtered by the horizontal filter kernel K₁ centered at the first image point IP₁ and an intermediate output image OUT₁ is produced. In parallel, the input image IN comprising a second image point IP₂ located in a second vicinity of the first image point IP₁ is filtered by the horizontal filter kernel K₁ centered at the second image point IP₂ and a second intermediate output image OUT2 is produced. In parallel, the input image IN comprising a third image point IP₃ located in a third vicinity of the first image point IP₁ is filtered by the horizontal filter kernel K₁ centered at the third image point IP₃ and a third intermediate output image OUT₃ has been produced.

The three intermediate output image OUT₁, OUT₂, OUT₃ are further linearly combined to produce a response of the input image to an elongated horizontal filter kernel K in accordance with the invention.

It should be noted that the steerable kernels used for designing the elongated filter kernel are not necessarily computed using second order derivatives of an isotropic function. The first order is for instance useful for border detection.

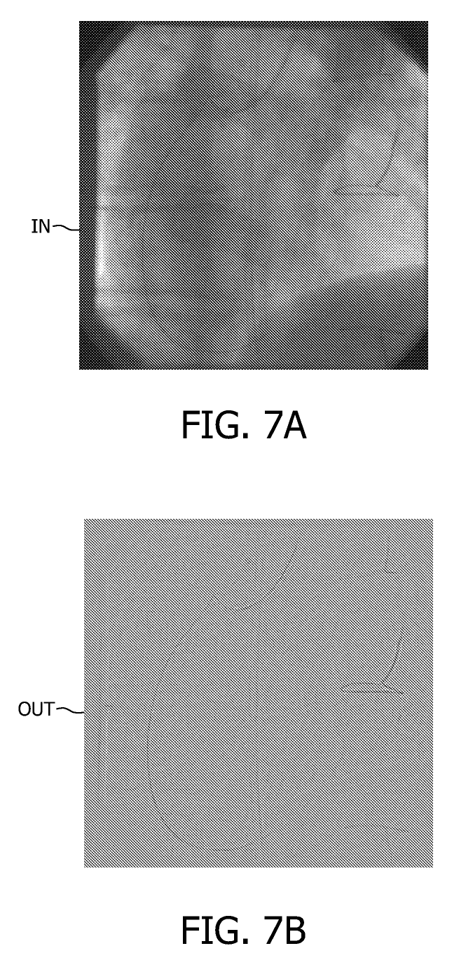

An example of application is given in FIGS. 7A and 7B for guide wire detection in X-ray cardio-vascular image. The input image IN is presented in FIG. 7A, the output image OUT is presented in FIG. 7B.

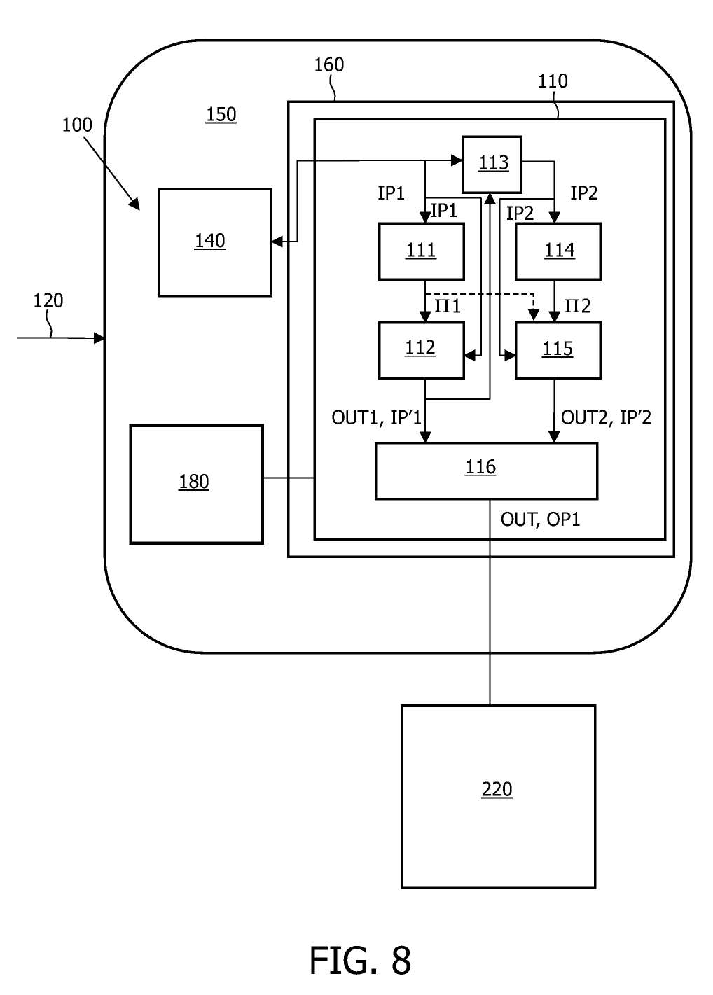

Referring to FIG. 8, a computer system including a system 110 for filtering an input image and producing an output image in accordance with the invention is presented. The computer system 100 includes an image data signal input 120 and a memory 140 for storing input image data into the system through the input 120. The system for filtering 110 includes a processor 160 that is programmed to control input image data processing in accordance with the present invention, along with a system power source 180. The computer system also includes a video monitor 200 which receives the processed output image from the processor via output 220. The method of designing and using elongated steerable filters in accordance with the invention may be programmed by a computer program through a conventional programming language into the memory 140 and utilized by the system 110. Alternatively the system 110 may be implemented through hardware.

The system 110 in accordance with the invention comprises:
means 111 for analysing intensity levels of the input image IN in a first vicinity V₁ of a first image point IP₁ to which are associated first spatial coordinates, for calculating a first direction of filtering at said first image point;
means 112 for computing an intensity level of a first output image point IP′₁ by applying first steerable filter kernel K₁, which is centered at the first image point IP₁ and oriented along the calculated first direction of filtering θ₁;
means 113 for selecting at least one second image point IP₂ in a second vicinity V₂ of said first output image point IP′₁;
means 115 for computing an intensity level of at least one second output image point IP′₂ by applying a second steerable filter kernel K₂, which is centered at said second image point IP₂ and oriented along a second direction of filtering θ₂;
means 116 for calculating a linear combination of the intensity levels of the first output image point IP′₁ and of the at least second output image point IP′₂;
means for applying said calculated linear combination to an intensity level of a final output image point OP₁ of said output image OUT, to which are associated said first spatial coordinates.

In an embodiment of the invention, the second direction of filtering θ₂ is equal to the first direction of filtering θ₁. An advantage is that the produced elongated steerable filter is straight.

In another embodiment of the invention, the system comprises means 114 for analysing intensity levels of the input image IN in a vicinity of a second image point IP₂ to which are associated first spatial coordinates, for calculating the second direction of filtering θ₂ at said second image point IP₂. An advantage is that the produced filter can be curved in order to better follow the direction of the elongated features present in the image.

The drawings and their description hereinbefore illustrate rather than limit the invention. It will be evident that there are numerous alternatives, which fall within the scope of the appended claims. In this respect the following closing remarks are made: there are numerous ways of implementing functions by means of items of hardware or software, or both. In this respect, the drawings are very diagrammatic, each representing only one possible embodiment of the invention. Thus, although a drawing shows different functions as different blocks, this by no means excludes that a single item of hardware or software carries out several functions, nor does it exclude that a single function is carried out by an assembly of items of hardware or software, or both. Any reference sign in a claim should not be construed as limiting the claim. Use of the verb “to comprise” and its conjugations does not exclude the presence of elements or steps other than those stated in a claim. Use of the article “a” or “an” preceding an element or step does not exclude the presence of a plurality of such elements or steps.

1. A method of filtering an input image for producing an output image, said input image comprising image points comprising intensity levels to which are associated spatial coordinates, said method comprising the steps of, for a first image point located at first spatial coordinates:
analysing intensity levels of the input image in a first vicinity of the first image point for calculating a first direction of filtering at said first image point;
computing an intensity level of a first output image point of a first output image by applying a first steerable filter kernel to the input image, which is centered at the first image point and oriented along the calculated first direction of filtering;
selecting at least a second image point in a second vicinity of said first image point in the first output image;
computing an intensity level of at least one second output image point of a second output image by applying at least a second steerable filter kernel to the input image, which is centered at the at least second image point and oriented along a second direction of filtering;
calculating a linear combination of the first output image point and of the at least second output image point for providing an output intensity level;
applying said output intensity level to an output image point of said output image, said output image point having said first spatial coordinates.

2. The method of claim 1, wherein in said step of computing an intensity level of a first output image point and/or in said step of computing an intensity level of a second output image point the intensity levels are computed by applying a Gaussian kernel to the input image.

3. The method of claim 1, wherein the at least second output image point is located on a line comprising the first output image point and oriented along the calculated first direction of filtering.

4. The method of claim 1, wherein the at least second output image point is located on a curve, comprising the first output image point, said curve being determined from a step of analysing intensity levels of the first output image in a vicinity of the first output image point.

5. The method of claim 1, wherein the second steerable filter kernel is oriented along the calculated first direction of filtering.

6. The method of claim 1, comprising the step of analysing intensity levels of the input image in a vicinity of said at least second image point for calculating a second direction of filtering at said at least second image point.

7. The method of claim 1, wherein the step of selecting at least a second image point comprises a sub-step of selecting a third image point in a third vicinity of said first image point and the step of an intensity level of one at least second output image point comprises a sub-step of computing an intensity level of a third output image point, which is centered at the third image point and oriented along a third direction of filtering and
wherein the combination step is intended to calculate the linear combination of the first steerable filter kernel centered at the first image point, of the second steerable filter kernel centered at the second image point and of a third steerable filter centered at the third image point.

8. The method of claim 7, wherein the third output image point is located on a line comprising the first output image point and the second output image.

9. The method of claim 7, wherein the third output image point is located on a curve comprising the first output image point and the second output image, said curve being determined from a step of analysing intensity levels of the first output image in a vicinity of the first output image point.

10. The method of claim 7, wherein the third steerable filter kernel is oriented along the calculated second direction of filtering.

11. The method of claim 8, wherein the third image point is selected in such a way that said third image point is symmetric, on the line, to the second image point with respect to the first image point.

12. The method of claim 9, wherein the third image point is selected in such a way that said third image point is symmetric, on the curve, to the second image point with respect to the first image point.

13. A system for filtering an input image and producing an output image, said input image comprising image points comprising intensity levels, to which are associated spatial coordinates, said system comprising:
means for analysing an intensity level of the input image in a first vicinity of a first image point for calculating a first direction of filtering at said first image point;
means for computing an intensity level of a first output image point by applying first steerable filter kernel, which is centered at the first image point and oriented along the calculated first direction of filtering;
means for selecting at least one second image point in a second vicinity of said first output image point;
means for computing an intensity level of at least one second output image point by applying a second steerable filter kernel, which is centered at said second image point and oriented along a second direction of filtering;
means for calculating a linear combination of the intensity levels of the first output image point and of the at least second output image point;
means for applying said calculated linear combination to an intensity level of a final output image point of said output image, to which are associated said first spatial coordinates.

14. A computer program product for a computer, comprising a set of instructions, which, when loaded into said computer, causes the computer to carry out the method as claimed in claim 1.
